(19) United States
(12) Patent Application Publication
(10) Pub. No.: US 2025/0262574 A1
(43) Pub. Date: Aug. 21, 2025

(54) Filter Device

(71) Applicant: HYDAC Process Technology GmbH, Neunkirchen (DE)

(72) Inventors: Bernhard Schlichter, Saarbrücken (DE); Jörg Hermann Gerstner, Püttlingen (DE); Dimitri Bugrov, Marpingen (DE); Julian Schmidt, Merchweiler (DE)

(73) Assignee: HYDAC Process Technology GmbH, Neunkirchen (DE)

(21) Appl. No.: 18/855,180

(22) PCT Filed: Apr. 24, 2023
(86) PCT No.: PCT/EP2023/060680

§ 371 Date: Oct. 8, 2024

(30) Foreign Application Priority Data
May 5, 2022 (DE) 10 2022 204 446.0

(51) Int. Cl. B01D 29/68; B01D 29/56; B01D 36/02

(52) U.S. Cl. CPC B01D 29/68; B01D 29/56; B01D 36/02; B01D 2201/48

(57) ABSTRACT

A filter device, in particular for processing, for example for filtering, backflush quantities which originate from a filter which can be arranged upstream of the filter device, having a primary stage for receiving the respective backflush quantity, a secondary stage for filtering off the backflush quantity from the primary stage, and a tertiary stage for returning the purified backflush quantity into a process circuit, wherein a flow divider is inserted in the primary stage and, if a predeterminable fluid quantity in the primary stage is exceeded, forwards the associated excess quantity into the tertiary stage while bypassing the secondary stage.

### CROSS-REFERENCE TO RELATED APPLICATIONS

This application claims priority to German Patent Application No. DE 10 2022 204 446.0, filed on May 5, 2022 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

To ensure the reliable and efficient operation of filter systems over prolonged operating periods, it is common practice, particularly with larger systems, to backflush and as a result regenerate the filter elements involved in the filtering process. During the respective backflush phases, a partial flow of the filtrate flows through the filter element to be cleaned in the reverse direction to remove the dirt from the element and discharge it together with the outflowing backflush quantity. Given the profoundly harmful impact on the environment of the backflush liquid polluted with the contamination, disposal is problematic. At least in the case of larger quantities of flushing liquid arising, post-treatment or processing is necessary, such as filtration to separate incinerable contamination. In the filtration of heavy fuel oils, such as those used, for example, to operate large diesel engines such as marine diesel engines, the high viscosity of the heavy fuel oil also complicates both the backflushing process in the primary filter, which is connected upstream of the filter device doing the processing, and the filter process to be carried out for processing.

In many process applications, such primary or automatic filters are used as protective filters, the backflush quantity arising during backflushing often being discharged back into the process cycle without further treatment. In ballast water treatment on ships, seawater is automatically filtered in the first treatment stage and the backflush liquid arising in the process is returned to the sea. The situation is similar with automatic filters which protect the heat exchangers in the cooling circuit of a power plant from coarse contaminants in the river water. Here too, it is possible to discharge the backflush liquid back into the surface waters. In some industrial processes, however, it may be necessary, due to the fluid and its constituents, to reprocess the backflush quantity in order to re-use the fluid and close the process cycle without environmental contact.

For this purpose, DE 10 2015 002 767 A1 describes a filter device, in particular for processing, preferably for filtering backflush quantities which originate from a filter that can be arranged upstream of the filter device, with a
primary stage for receiving the respective backflush quantity,
a secondary stage for filtering off the backflush quantity from the primary stage, and
a tertiary stage for returning the cleaned backflush quantity to a process cycle.

In this solution, respective backflush quantities are fed to the relevant filter element in batches by a control device, which means that reliable filtration can be carried out even at higher viscosity, for example within the scope of heavy fuel oil filtration. In this case, the control device has a control chamber with a separating piston, which divides the control chamber into a first and a second fluid chamber, the first fluid chamber being used to accommodate the respective backflush quantity and the second fluid chamber being acted upon by a pressurised gas with a predefinable working pressure, so that the backflush quantity is displaced from the first control chamber by means of the separating piston into an adjoining filter chamber with filter element, which filter element returns the backflush quantity thus filtered and processed in such a way to the process cycle. Although this known solution results in very good processing results for the backflush quantity from primary or automatic filters, in practice it has been shown that the known solution reaches its limits when large quantities of backflush fluid arise. The backflush quantity arising in an automatic filter is highly dependent on the process conditions and in this respect can vary greatly, in particular it can result in very high quantities of backflush liquid for post-treatment. The fact that, in the known solution, the separating piston has to be moved in or out each time to accommodate the backflush fluid and to transfer it to the filter chamber means that continuous operation is not possible, so that the known processing system for backflush quantities reaches its limits particularly with large quantities of backflush fluid.

### SUMMARY

A need exists to provide an improved backflush fluid filter device. The need is addressed by the subject matter of the independent claim(s). Embodiments of the invention are described in the dependent claims, the following description, and the drawings.

### BRIEF DESCRIPTION OF THE DRAWINGS

FIG. 1 shows example components of a filter device for the backflush quantity processing in the manner of a simplified process diagram;

FIG. 2 shows a perspective top view of example components of such a system according to FIG. 1; and

FIG. 3 shows a simplified diagram of a bag or pocket filter used in the example filter device according to FIGS. 1 and 2.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a flow divider is inserted in the primary stage which, if a predefinable fluid quantity in the primary stage is exceeded, transfers the associated excess quantity into the tertiary stage while bypassing the secondary stage.

This means that a solution is provided with which continuous operation is possible within the scope of processing the backflush fluid, so that even extremely large quantities of backflush fluid can be reliably reprocessed and returned to the process cycle.

The solution is very reliable and the flow divider referred to permits a kind of bypass operation using different filter stages, a type of fine filter continuously filtering backflush quantities arising and, in the event of excess quantities, these are diverted via the flow divider and subjected to coarse filtration which is to be carried out quickly, so that in this way even very large quantities of backflush fluid are manageable. Ultimately, the residual fluid quantities enter the subsequent tertiary stage as part of both fine filtration and coarse filtration, which enables the correspondingly cleaned backflush quantities to be discharged into the otherwise closed process cycle of the system.

If an even larger quantity of backflush liquid accumulates in the short term and the liquid level within the primary stage, in the form of a depressurised feed tank, exceeds the installation height of the filter or screen basket, an additional but now untreated partial flow flows out through the upper opening of the screen basket via its bottom end towards the tertiary stage. This ensures that the receiving tank of the backflush quantity processing unit can never overflow and that, even with the maximum backflush quantity arising, there will never be a backflow which would ultimately result in shutdown of the backflush processing filter.

Irrespective of the foregoing considerations, the backflush quantity processing unit is of course also suitable if backflush quantities to be processed by the primary or automatic filter reach the filter device according to the teachings herein intermittently and only on a small scale.

In some embodiments of the filter device, it is provided that the flow divider has a backflushing device which cleans it of contamination that reaches the unfiltered medium side of the primary stage. In this case, the backflushing device for the flow divider is for example formed of a drivable backflush arm which can be moved along the screen basket on the inner circumference thereof and guides a backflush fluid from inside to outside through the screen structure of the screen basket. To be able to clean the filter screen, which in this respect is cylindrical, when necessary, a flushing device is therefore arranged axially in the filter or screen basket which uses spray nozzles, for example, to force clean fluid, such as tap water, through the filter or screen material of the basket from inside to outside with pressure and counter to the direction of filtration.

The dirt removed during the aforementioned backflushing process can then settle in the feed or receiving tank and, as part of the backflush liquid which is normally to be treated, is finally transported to the secondary stage, which consists of individual filter units that comprise a bag or pocket filter, which is connected with its unfiltered medium side to the primary stage and with its filtrate side to the tertiary stage. In this manner, the feed tank can be kept free of contamination even during lengthy operation. It is for example provided that the inflow from the primary or automatic filter into the feed tank always takes place below the bottom end of the filter or screen basket and outside the longitudinal axis in a tangential incident flow, so that a cyclonic flow is created in the feed tank.

In this case, it is for example provided to monitor the fill level in the feed tank to monitor the system status. In this way, for example, a signal can be transmitted to a higher-level control system, which, among other things, controls the primary or automatic backflushing filter, as soon as partial flows are generated towards the tertiary stage via the screen basket or the overflow formed in this manner.

In some embodiments of the filter device, it is provided that a plurality of filter units are interconnected in parallel arrangement in such a manner that at least one bag or pocket filter of a filter unit can be exchanged for a new unit, whereas the other filter units continue to clean the backflush quantities arising of contamination. This makes it possible to replace the filter with bag or pocket filters without having to interrupt continuous filtration by the secondary stage.

The solution according to the teachings herein is discussed in greater detail in the following with reference to the drawings. The drawings are schematic and not to scale. Specific references to components, process steps, and other elements are not intended to be limiting.

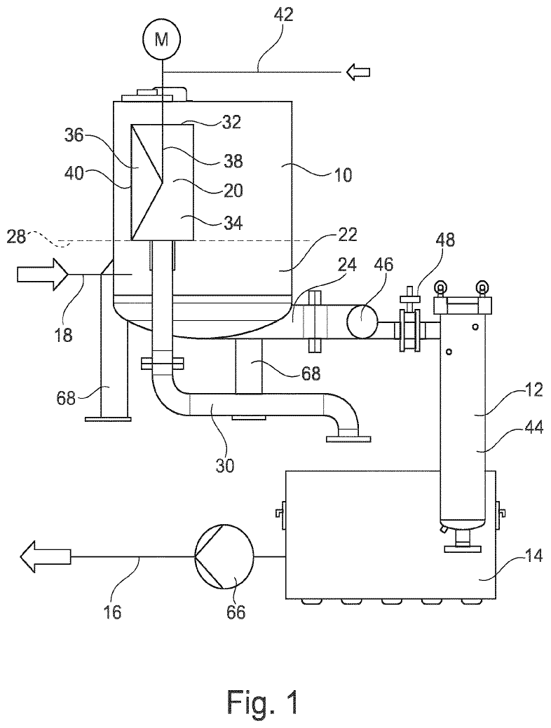

As FIG. 1 shows, the filter device for backflush quantity processing has a primary stage 10 for receiving the respective backflush quantity and a secondary stage 12 for filtering off the backflush quantity from the primary stage 10. Furthermore, a tertiary stage 14 for returning the cleaned backflush quantity to a process cycle 16 of an overall system, which is only partially shown in FIG. 1. The primary stage 10 has a fluid inlet 18, which is part of the process cycle 16 and which, viewed in the direction of the arrow, allows the inflow of backflush fluid in a tangential direction, so that a cyclonic inlet flow is achieved within the primary stage 10.

The fluid inlet 18, which is not shown in greater detail, is connected in a fluid-conducting manner to the fluid outlet for backflush quantity fluid, for example to the corresponding outlet of the backflushing filter according to DE 10 2004 037 280 A1.

A flow divider 20 is inserted into the primary stage 10 which, if a predefinable fluid quantity in the primary stage 10 is exceeded, transfers the associated excess quantity directly into the tertiary stage 14 while bypassing the filtering secondary stage 12.

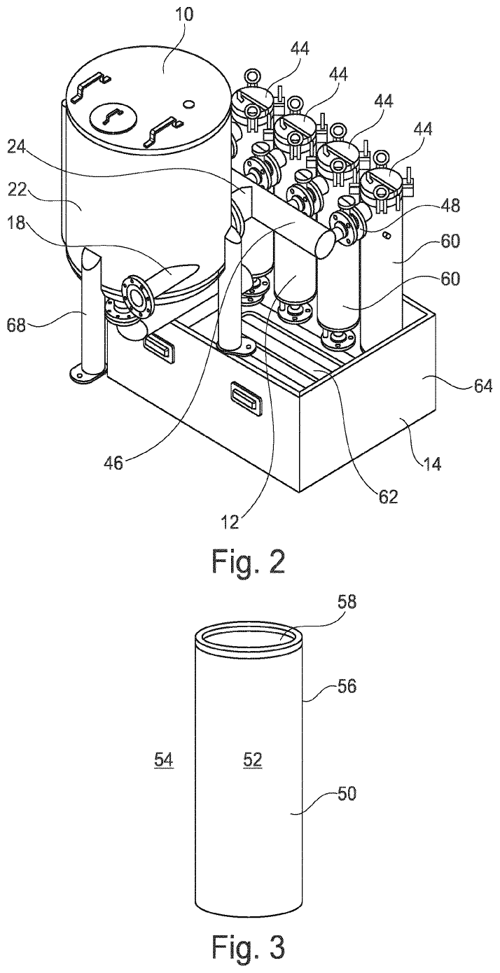

As FIGS. 1 and 2 further show, the primary stage 10 has a feed tank 22 which is kept depressurised and has an inlet via the fluid inlet 18 for the respective backflush quantity from the backflushing filter device and an outlet 24 for discharging the aforementioned backflush quantity to the secondary stage 12. Depressurised means that the feed tank 22 has ambient pressure inside.

The flow divider 20 referred to is formed of a hollow cylindrical screen basket 26, which is arranged above a predefinable lower fill level limit 28 in the feed tank 22 and is connected via a fluid connection 30 to the tertiary stage 14 into which the backflush quantity filtrate of the secondary stage 12 can be discharged. The screen basket 26 forms an overflow with its upper opening 32 for an excess quantity in the feed tank 22, the aforementioned excess quantity which overflows the upper edge of the screen basket 26 being dischargeable to the tertiary stage 14 via the interior 34 of the screen basket 26 and the fluid connection 30. The aforementioned fluid connection 30 is formed of a pipe which opens with its one open end into the bottom of the screen basket 26 and after passing through the bottom of the feed tank 22 opens with its other open end above the tertiary stage 14.

As can further be seen from FIG. 1 and which is not shown in FIG. 2, the flow divider 20 has a backflushing device 36 which is only shown in principle in FIG. 1. The backflushing device 36 allows the outside of the screen basket 26 to be cleaned of contamination that reaches the unfiltered medium side of the primary stage 10 in that it is carried into the feed tank 22 and settles on the outside of the screen material of the screen basket 26. The backflushing device 36 for the flow divider 20 has a drivable backflush arm 38 which is driven circumferentially along the inside of the screen basket 26 by an electric motor M. According to the diagram shown in FIG. 1, the backflush arm 38 has a conically extending flushing device 40 at the end which, provided with individual spray nozzles (not shown), opens up the possibility of forcing clean fluid, for example tap water, through the filter or screen material of the screen basket 26 from inside to outside with pressure and counter to the filtration direction, so that said screen basket is cleaned of particle contamination which sinks towards the bottom of the feed tank 22 due to gravity. A flushing line 42 which cooperates with the backflush arm 38 is used to supply the clean fluid and allows the cleaning liquid to be distributed via the spray nozzles of the flushing device 40. The flow direction of the flushing fluid is shown in turn by an arrow in FIG. 1.

As can be seen in particular from FIG. 2, the secondary stage 12 is formed of individual filter units 44, with four filter units 44 being used in the present case. The four filter units 44 are supplied at the top by a horizontal distribution line 46 which is connected to the outlet 24 of the feed tank 22. A manually operated shut-off valve 48 is connected between the distribution line 46 and each top-end inlet of a filter unit 44. A bag or pocket filter 50 is inserted in each filter unit 44, as is shown by way of example in its operating position in FIG. 3. The respective bag or pocket filter 50 is connected with its unfiltered medium side 52 to the primary stage 10 and with its filtrate side 54 to the tertiary stage 14. The fluid to be cleaned flows through the bag or pocket according to the diagram of FIG. 3 from inside to outside and any particulate contamination present in the backflush fluid is deposited on the element material 56 of the filter from the inside. In the present case, the filter is open at the top and closed at the bottom, so that unfiltered medium flows into the uncovered opening 58 from above, starting from the open shut-off valve 48. The backflush fluid cleaned by the element material 56 then reaches the filtrate side 54, formed of a cavity between the outer circumference of the cylindrical element material 56 and the cylindrical inner circumference of the filter housing 60 for a filter unit 44.

As can further be seen from FIG. 2, the filter housings 60 of the individual filter units 44 rest at the bottom on a grate 62 of the tertiary stage 14, which in this respect is formed of a rectangular discharge tank 64. In this respect, the backflush fluid cleaned by means of the filter units 44 can collect in the discharge tank 64 before it is returned to the process cycle 16 by means of a negative pressure or vacuum pump 66, viewed in the direction of the arrow.

Such bag or pocket filters 50 according to the diagram of FIG. 3 can be used as surface filters and as deep-bed filters. A textile filter medium is for example used for the element material 56, the filter fineness for the bag or pocket filter 50 being selected in any case, in the context of a type of fine filtration, to be significantly finer than the filter fineness for the screen body of the screen basket 26. In this respect, the cleaned backflush quantity of fluid can settle in any case in the discharge tank 64 before it is pumped back into the fluid cycle 16 via the vacuum pump 66.

As can further be seen from FIG. 2, the feed tank 22 is elevated with respect to the upper side of the discharge tank 64 by means of individual support legs 68, so that the fluid connection 30 to the screen basket 26 opens out with its lower free end above the discharge tank 64. In any case, the flow divider 20 is only used if the fluid level of backflush quantity exceeds the lower fill level limit 28 in the feed tank 22; otherwise the backflush quantity to be cleaned reaches the outlet 24 directly via the fluid inlet 18 and via the interior of the feed tank 22 and from there via the distribution line 46 and the individual open shut-off valves 48 similarly to the filter units 44. Since, according to the diagram of FIG. 2, a plurality of filter units 44 are interconnected in parallel arrangement in such a manner that at least one bag or pocket filter 50 of a filter unit 44 can be exchanged from above for a new unit (see FIG. 3), the other filter units 44 can continue to clean the backflush quantities of contamination arising, so that a continuous treatment process for backflush quantities is enabled.

As already explained, the arising backflush quantities of an automatic filter, for example according to the teaching of DE 10 2004 037 280 A1, are highly dependent on the process conditions and therefore vary greatly. The flushing frequency is directly dependent on the dirt concentration and the filter fineness selected in the primary filter. A medium-sized filter of this type, for example, produces a liquid quantity of 500 litres per backflush during a flushing time of approx. 10 seconds. A typical design provides for a filter to be flushed around four times per hour; accordingly, 2 m³/h of backflush liquid would accumulate for further processing.

Since the dirt concentration on the unfiltered medium side of a backflushing filter is rarely constant and the volume flows can also vary at times, such filters also flush more frequently in practice; therefore, basically anything from continuous flushing to one flush per hour is possible and also realistic in exceptional cases. For the example assumed here, this means that a backflush quantity of 0.5 m³ to 180 m³/h could arise for this one medium-sized backflushing filter. If the backflush quantity arising is to be processed within the scope of a second stage, i.e. with the backflush quantity processing device according to the teachings presented here, the question then arises as to how large this treatment stage must be. If an interruption of the overall process is ruled out, i.e. a shutdown of the backflushing filter as the primary or automatic filter, the backflush quantity processing would have to be designed for the worst case, i.e. be designed to treat 180 m³/h. Such a design would ultimately lead to very large and therefore costly devices, for which a corresponding approach is shown in DE 10 2015 002 767 A1, which experience has demonstrated calls the implementation of such an overall solution into question. The associated investment would be disproportionately expensive.

However, since the focus is often only on process reliability, it has now been recognised as more than reasonable to implement a smaller backflush quantity processing device according to the teachings herein and to accept that at times the whole backflush quantity will not be optimally fine-filtered via the filter units 44 but that, depending on the flushing quantity arising, partial flows will be transferred via the coarser filter with the screen basket 26 or, if necessary, even returned to the process cycle 16 via the bypass function of the flow divider 20, without further treatment via the tertiary stage 14. This solution thus has no equivalent in prior art.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

A single processor, device, or other unit may be arranged to fulfil the functions of several items recited in the claims. Likewise, multiple processors, devices, or other units may be arranged to fulfil the functions of several items recited in the claims. The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A filter device, comprising:
a primary stage for receiving the respective backflush quantity;
a secondary stage for filtering off the backflush quantity from the primary stage; and
a tertiary stage for returning the cleaned backflush quantity to a process cycle; wherein
a flow divider is inserted in the primary stage which, if a predefinable fluid quantity in the primary stage is exceeded, transfers the associated excess quantity into the tertiary stage while bypassing the secondary stage.

12. The filter device of claim 11, wherein the primary stage has a feed tank which is kept depressurised and has an inlet for the respective backflush quantity from the filter and an outlet for discharging the aforementioned backflush quantity to the secondary stage.

13. The filter device of claim 11, wherein the flow divider is formed of a screen basket which, arranged above a predefinable lower fill level limit in the feed tank, is connected via a fluid connection to the tertiary stage into which the backflush quantity filtrate of the secondary stage can be discharged.

14. The filter device of claim 11, wherein the screen basket forms an overflow with an upper opening for an excess quantity in the feed tank which can be discharged to the tertiary stage via the interior of the screen basket and the fluid connection.

15. The filter device of claim 11, wherein the flow divider has a backflushing device which cleans it of contamination that reaches the unfiltered medium side of the primary stage.

16. The filter device of claim 11, wherein the backflushing device for the flow divider is formed of a drivable backflush arm which can be moved along the screen basket on the inner circumference thereof and guides a backflush fluid from inside to outside through the screen structure of the screen basket.

17. The filter device of claim 11, wherein the secondary stage consists of individual filter units which comprise a bag or pocket filter that is connected to the primary stage with its unfiltered medium side and to the tertiary stage with its filtrate side.

18. The filter device of claim 11, wherein a plurality of filter units are interconnected in parallel arrangement in such a manner that at least one bag or pocket filter of a filter unit can be exchanged for a new unit, whereas the other filter units continue to clean the arising backflush quantities of contamination.

19. The filter device of claim 11, wherein the filter fineness of the screen basket is selected to be coarser than the filter fineness for the bag or pocket filter of a respective filter unit.

20. The filter device of claim 11, wherein the backflush quantity filtrate of the tertiary stage can be returned to the subsequent process cycle using a fluid pump.

21. The filter device of claim 11, configured for processing backflush quantities which originate from a filter which can be arranged upstream of the filter device.

22. The filter device of claim 11, configured for filtering backflush quantities which originate from a filter which can be arranged upstream of the filter device.

23. The filter device of claim 12, wherein the flow divider is formed of a screen basket which, arranged above a predefinable lower fill level limit in the feed tank, is connected via a fluid connection to the tertiary stage into which the backflush quantity filtrate of the secondary stage can be discharged.

24. The filter device of claim 12, wherein the screen basket forms an overflow with an upper opening for an excess quantity in the feed tank which can be discharged to the tertiary stage via the interior of the screen basket and the fluid connection.

25. The filter device of claim 13, wherein the screen basket forms an overflow with an upper opening for an excess quantity in the feed tank which can be discharged to the tertiary stage via the interior of the screen basket and the fluid connection.

26. The filter device of claim 12, wherein the flow divider has a backflushing device which cleans it of contamination that reaches the unfiltered medium side of the primary stage.

27. The filter device of claim 13, wherein the flow divider has a backflushing device which cleans it of contamination that reaches the unfiltered medium side of the primary stage.

28. The filter device of claim 14, wherein the flow divider has a backflushing device which cleans it of contamination that reaches the unfiltered medium side of the primary stage.

29. The filter device of claim 12, wherein the backflushing device for the flow divider is formed of a drivable backflush arm which can be moved along the screen basket on the inner circumference thereof and guides a backflush fluid from inside to outside through the screen structure of the screen basket.

30. The filter device of claim 13, wherein the backflushing device for the flow divider is formed of a drivable backflush arm which can be moved along the screen basket on the inner circumference thereof and guides a backflush fluid from inside to outside through the screen structure of the screen basket.
